(19) United States
(12) Patent Application Publication
(10) Pub. No.: US 2001/0050924 A1
(43) Pub. Date: Dec. 13, 2001

(54) Method of inserting data of a second type into an input stream of a first type

(76) Inventors: Laurent Herrmann, Le Kremlin-Bicetre (FR); Francois Martin, Paris (FR)

Correspondence Address: Jack E. Haken, U.S. Philips Corporation, 580 White Plains Road, Tarrytown, NY, 10591, US

(21) Appl. No.: 09/812,429

(22) Filed: Mar. 20, 2001

(30) Foreign Application Priority Data
Mar. 27, 2000 (EP) 00400840.5
Aug. 29, 2000 (EP) 00402388.3

(51) Int. Cl. H04J 1/02

(52) U.S. Cl. 370/493

(57) ABSTRACT

The invention proposes a method of generating, from an input transport stream of a first type and from data of a second type, an output transport stream of said first type which notably carries said data of said second type. This method consists of:

generating an intermediate transport stream by creating available bandwidth in the input transport stream,

inserting the data of the second type into the available bandwidth of the intermediate transport stream, thereby generating the output transport stream.

The method notably applies to the generation of an MPEG-2 output transport stream from an MPEG-2 input transport stream and from MPEG-4 data. In this case an additional updating step is necessary to update PSI tables.

The present invention relates to a server intended for generating, from an input transport stream of a first type and from data of a second type, an output stream of said first type which notably carries said data of said second type. More specifically the invention relates to a server intended for generating from an input MPEG-2 transport stream and from MPEG-4 data, an output MPEG-2 transport stream which notably carries said MPEG-4 data.

The invention also relates to a method of generating, from an input transport stream of a first type and from data of a second type, an output transport stream of said first type which notably carries said data of said second type.

The invention further relates to a broadcasting system comprising such a server, and to a computer program for implementing such a method.

It is known to transport data of a second type in a transport stream of a first type. For example, the transport of MPEG4 data over MPEG2 systems is described in the standardization document ISO/IEC JTC1/SC29/WG11N3050 published by the ISO in January 2000 under the title “Information Technology—Generic Coding of Moving Pictures and Audio: Systems; Amendment 7: Transport of ISO/IEC 14496 data over ISO/IEC 13818-1”.

One of the objects of the invention is to propose an advantageous way of generating said output transport stream. This is achieved with a server as described in the opening paragraph, said server having:

first means for generating an intermediate transport stream by creating available bandwidth in said input transport stream,

second means for inserting said data of said second type in the available bandwidth of said intermediate transport stream, thereby generating said output transport stream.

One advantage of the invention is that it avoids a complete demultiplexing of the input stream, thereby reducing the computing cost of the proposed functionality.

In an important embodiment of the invention, particularly suited for MPEG-2/MPEG-4 applications, the input transport stream carries control information and the server has third means, upstream of said second means, for updating said control information to take said data of said second type into account.

When the bit rate of the transport stream must not be increased, the available bandwidth is advantageously created as indicated in claim 2 of the present patent application.

When the bit rate of the transport stream must be increased, the available bandwidth is advantageously created as indicated in claim 3 of the present patent application.

These and other aspects of the invention will be apparent from and elucidated with reference to the description and the drawings hereinafter.

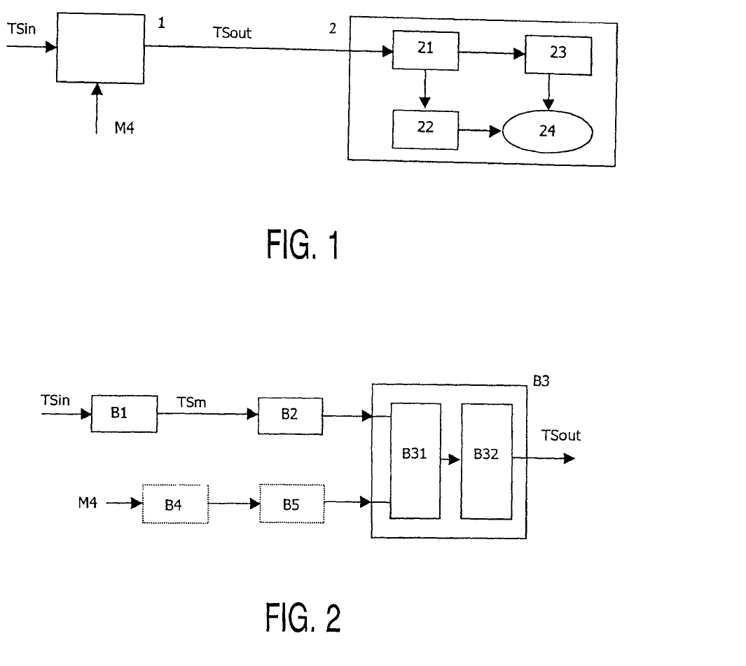

FIG. 1 is a schematic representation of a broadcasting system according to the invention;

FIG. 2 is a functional diagram showing the operations to be executed by the server for generating the output transport stream;

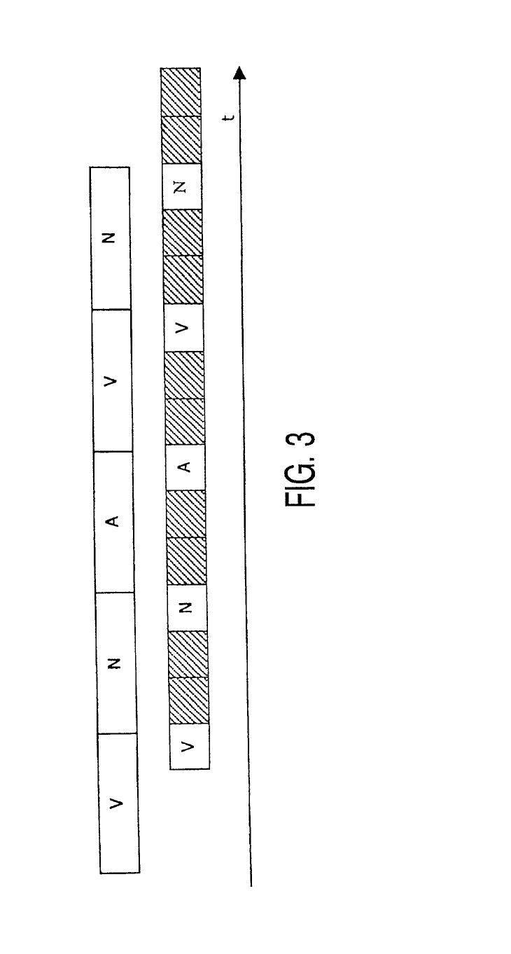

FIG. 3 is a schematic representation of the operation of bandwidth creation in a first embodiment of the invention,

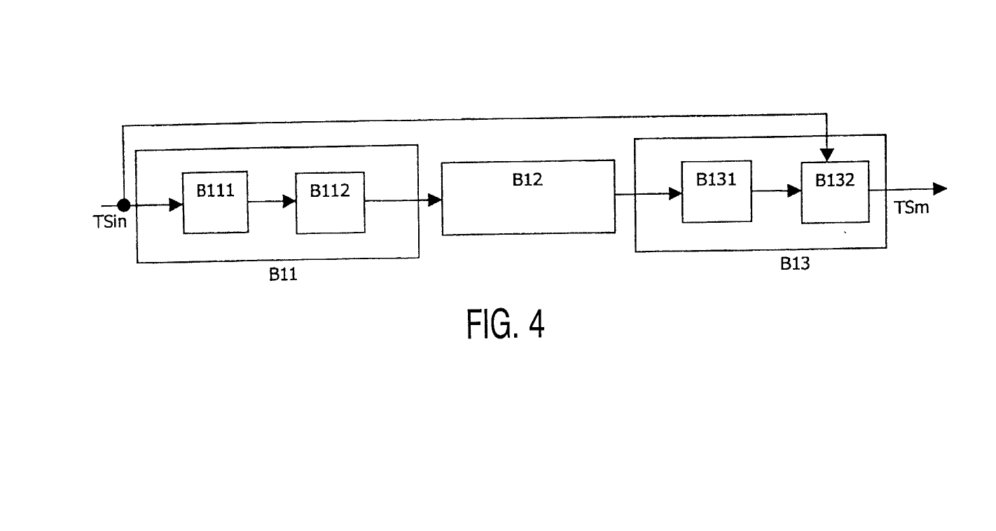

FIG. 4 is a functional diagram describing the operation of bandwidth creation in a second embodiment of the invention.

In the whole description the transport streams of the first type are MPEG-2 transport streams and the data of the second type are MPEG-4 data. This is not restrictive.

FIG. 1 gives a schematic representation of a broadcasting system according to the invention. This broadcasting system comprises a server 1 intended for generating from an input MPEG-2 transport stream TSin, and from MPEG-4 data M4, an output MPEG-2 transport stream TSout which notably carries the data M4. The broadcasting system also comprises terminal equipment 2 comprising a demultiplexing unit 21, an MPEG-4 engine 22, and an MPEG-2 audio/video decoder 23, for retrieving MPEG-2 and MPEG-4 data to be used by a client application 24.

According to the MPEG-2 standard, system information is transmitted in the form of tables called PSI tables (PSI stands for Program System Information). These tables constitute the control information of the invention. Their function is to indicate how the stream is constituted: it may be constituted by one or more elementary video streams, one or more elementary audio streams, and of MPEG-4 data streams. In the transport stream, all data (MPEG-2 video, MPEG-2 audio, and MPEG-4 data) are interleaved. The PSI tables are used at the reception to reconstitute the programs.

FIG. 2 gives a representation in blocks of the operation to be executed by the server 1 in order to generate the output transport stream TSout. According to FIG. 2, the input transport stream TSin is delivered to a bandwidth creation block B1. The bandwidth creation block B1 generates an intermediate transport stream TSm having available bandwidth. The intermediate transport stream TSm is delivered to an updating block B2. The function of the updating block B2 is to update the PSI tables carried in the intermediate transport stream TSm in order to take into account the presence of the data M4. After updating, the intermediate transport stream TSm is delivered to an insertion block B3. The insertion block B3 also receives the data M4. Its function is to insert the data M4 in the available bandwidth of the intermediate transport stream TSm.

It is to be noted that MPEG-4 data may comprise audio and video data, but also Scene descriptions and Object descriptions. In the case where the data M4 contain Scene and Object descriptions it is necessary, in order to comply with the Amendment 7 of the MPEG-2 standard, for the data M4 to go through a synchronization layer and optionally a Flex/Mux layer before being delivered to the updating block B2 and to the insertion block B3. The function of the synchronization layer is to provide timing, synchronization, fragmentation and random access information relating to the elementary MPEG-4 streams. The function of the Flex/Mux layer is to interleave the MPEG-4 data originating from multiple MPEG-4 data streams. To achieve this, the server 1 optionally comprises a synchronization block B4 and a Flex/Mux block B5 which process the data M4 before delivering them to the updating block B2 and to the insertion block B3. Blocks B4 and B5 are represented in dotted lines in FIG. 2.

The way in which the PSI tables have to be modified to take into account the presence of MPEG-4 data in the MPEG-2 transport stream is defined in the Amendment 7 of the MPEG-2 standard.

In practice, MPEG-2 transport streams are made up MPEG-2 transport packets. The insertion block B3 comprises a mapping block B31 and a replacement block B32. The function of the mapping block B31 is to map the data M4 into MPEG-2 transport packets. The function of the replacement block B32 is to replace the null transport packets of the intermediate transport stream TSm with the transport packets containing the data M4. For example, the mapping operation is done as described in international patent application WO99/21337 filed by Koninklijke Philips Electronics N.V.

The invention proposes two ways of creating available bandwidth depending on the ability to increase the bit rate of the transport stream.

FIG. 3 illustrates a first embodiment of the bandwidth creation block B1 when it is possible to increase the bit rate of the transport stream. In this example the input transport stream TSin has a bit rate equal to R and comprises MPEG-2 video transport packets V, MPEG-2 audio transport packets A and null packets N. Two null transport packets N represented in hatched lines are inserted after each transport packet of the input transport stream TSin. In this example, the resulting intermediate transport stream TSm has a bit rate equal to 3R. In FIG. 3 the t axis represents the time.

FIG. 4 illustrates a second embodiment of the bandwidth creation block B1 when it is impossible to increase the bit rate of the transport stream. In this embodiment, the bandwidth creation block B1 comprises a demultiplexing block B11, a transcoding block B12, and a remultiplexing block B13. The demultiplexing block B11 receives the input transport stream TSin. Its function is to demultiplex one or more elementary video stream(s) carried in the input transport stream TSin. To achieve this the demultiplexing block B11 comprises a video packet extraction block B111 and a transport layer removing block B112. The function of block B111 is to extract the transport packets corresponding to said video elementary stream(s) from the input transport stream TSin. The function of block B112 is to remove the transport layer in order to retrieve the video data. The retrieved video data are delivered to the transcoding block B12. The function of the transcoding block B12 is to decode and re-encode the video data with a lower accuracy in order to reduce the bandwidth they occupy. The re-encoded data are delivered to the remultiplexing block B13. The remultiplexing block B13 comprises a mapping block B131 and a replacement block B132. The function of the mapping block B131 is to map the re-encoded video data into MPEG-2 transport packets. The function of the replacement block B132 is to replace the extracted video transport packets with the transport packets containing the re-encoded video data and null transport packets N. In this example, the replacement block B132 delivers an intermediate transport stream TSm which rate is equal to the bit rate of the input transport stream.

Coming back to FIG. 2 it is to be noted that the data M4 to be inserted into the MPEG-2 transport stream may be stored locally on the server 1. They may also be transmitted from another remote server, for example, over an IP link.

1. A server intended for generating, from an input transport stream of a first type and from data of a second type, an output transport stream of said first type which notably carries said data of said second type, said server having:
first means for generating an intermediate transport stream by creating available bandwidth in said input transport stream,
second means for inserting said data of said second type the available bandwidth of said intermediate transport stream, thereby generating said output transport stream.

2. A server as claimed in claim 1, wherein said input transport stream carries control information, and said server has third means, upstream of said second means, for updating said control information to take said data of said second type into account.

3. A server as claimed in one of claims 1 or 2 wherein said streams of the first type are composed of transport packets, and the creation of available bandwidth is made by inserting null packets into the input transport stream, so that said intermediate transport stream has a higher bit rate than said input transport stream.

4. A server as claimed in one of claims 1 or 2 wherein said transport streams of the first type are composed of transport packets, said input transport stream carries a plurality of elementary streams containing encoded data, and the creation of available bandwidth is made by:
selecting one or more elementary stream(s) in said input transport stream,
demultiplexing the selected elementary stream(s),
transcoding the encoded data contained in the demultiplexed elementary stream(s) in order to reduce the bit rate they occupy
and remultiplexing said transcoded data while inserting null transport packets so that the generated intermediate transport stream has a bit rate that is smaller or equal to the bit rate of said input transport stream.

5. A broadcasting system comprising at least a server as claimed in one of claims 1 or 2 and a client terminal intended to receive the output transport stream delivered by said server and to retrieve the data carried in this transport stream in view of a use in a client application.

6. A method of generating, from an input transport stream of a first and from data of a second type, an output transport stream of said first type which notably carries said data of said second type, said method having:
a first step of generating an intermediate transport stream by creating available bandwidth in said input transport stream,
a second step of inserting said data of said second type into the available bandwidth of said intermediate transport stream, thereby generating said output transport stream.

7. A method as claimed in claim 6 wherein said input transport stream carries control information and said method has a third step, upstream of said second step, of updating said control information to take said data of said second type into account.

8. A method as claimed in one of claims 6 or 7 wherein said transport streams of the first type are composed of transport packets, and the creation of available bandwidth is made by inserting null packets into the input transport stream, so that said intermediate transport stream has a higher bit rate than said input transport stream.

9. A method as claimed in one of claims 6 or 7 wherein said transport streams of the first type are composed of transport packets, said input transport stream carries a plurality of elementary streams containing encoded data, and the creation of available bandwidth is made by:
selecting one or more elementary stream(s) in said input transport stream,
demultiplexing the selected elementary stream(s),
transcoding the encoded data contained in the demultiplexed elementary stream(s) in order to reduce the bit rate they occupy,
and remultiplexing said transcoded data while inserting null transport packets so that the generated intermediate transport stream has a bit rate that is smaller or equal to the bit rate of said input transport stream.

10. A computer program having means for implementing a method as claimed in one of claims 6 or 7.
